(19) United States
(12) Patent Application Publication
(10) Pub. No.: US 2023/0267412 A1
(43) Pub. Date: Aug. 24, 2023

(54) APPARATUS AND METHOD FOR CONTROLLING THE DISTRIBUTION OF A PLURALITY OF DIFFERENT GOODS

(71) Applicant: WITRON LOGISTIK + INFORMATIK GMBH, Parkstein (DE)

(72) Inventor: Walter WINKLER, Parkstein (DE)

(21) Appl. No.: 18/000,532

(22) PCT Filed: Jun. 2, 2021
(86) PCT No.: PCT/EP2021/064796

§ 371 Date: Dec. 2, 2022

(30) Foreign Application Priority Data
Jun. 4, 2020 (DE) 10 2020 003 376.8

(51) Int. Cl. G06Q 10/0875; G06Q 10/083

(52) U.S. Cl. CPC G06Q 10/0875; G06Q 10/0838

(57) ABSTRACT

A storage and distribution system designed for a plurality of different items comprises: a central warehouse for storing and picking the items in sales units and/or packing units, in which several sales units of an item are packaged, as well as a plurality of sales outlets for receiving the supplied items from the central warehouse and providing the items in sales and/or packing units. Each sales outlet has devices for logging sales and packing units of the delivered and sold items, and repacking between packing and sales units. The system also has a database device connected to the central warehouse and the sales outlets, designed for storing and updating the number of sales and packing units of each item stored in the central warehouse, and for storing and updating the number of sales and packing units of each item in stock in the sales outlets.

### FIELD OF THE INVENTION

The invention relates to a storage and distribution system as well as a computer-implemented method for controlling the storage, picking and distribution of a plurality of different goods, for example food and other consumer goods for daily needs.

### BACKGROUND OF THE INVENTION

Food and other goods for daily needs are currently distributed predominantly (>95%) via the traditional distribution channel of the retail industry, thus via supermarkets, discount stores and superstores of different sizes. A central large warehouse is typically responsible for the distribution of a supermarket chain in a geographically defined area (e.g. North Rhine-Westphalia, northern Bavaria). The goods (hereinafter also called “items”) are supplied to the central warehouse by the producers or haulage contractors, transferred to stock on pallets there, and registered in a database system. If a sales outlet, such as, say, a supermarket, orders new goods, these are picked in the central warehouse for transport to this supermarket and then delivered by lorry.

The central warehouse is equipped with a warehouse management system which logs all goods which have been delivered and transferred to stock, as well as goods supplied. The quantity of each product stored in the central warehouse can thus be removed from the warehouse management system at any time.

Additionally, it can be provided that fresh produce such as fruit, vegetables or dairy products are delivered directly by the producer or transport company to the sales outlet, in order to ensure the freshness of the products. When delivered to the sales outlet, preferably this fresh produce is logged and entered into the central warehouse management system.

The goods are delivered to the sales outlets typically in the form of packing units (boxes and the like, also called “cases”). Each packing unit contains several sales units (individual bottles, glasses or other single packs of the product, also called “pieces”). In the sales outlets, the goods are partially removed from the packing units and the sales units are placed in a store shelf. If there is not enough space in the store shelves, goods are frequently stored temporarily in adjoining rooms or buffer stores in the form of warehouse units and/or sales units.

Goods sold in the sales outlets are logged via cash registers and the sale of the goods also transferred to local software of the sales outlet and optionally also to the central management system.

Frequently, the problem arises that the goods stored in the adjoining rooms or the sales outlets, in the form of warehouse units or sales units, are forgotten. Occasionally, goods are ordered by the sales outlet on the basis of an empty shelf although there may still be enough of it left in stock in an adjoining room. Frequently, special offers or promotional merchandise in the sales outlets are particularly affected.

Such problems are exacerbated with increasing amounts of goods being ordered online (e-commerce) which are then delivered to the end at home, customer or made available for collection at collection points. In so doing, goods not supplied or returns are frequently sent back to the sales outlets. Efficient stock-keeping of different items in the sales outlets therefore represents a big challenge.

Therefore, the object of the present invention is proposing a storage and distribution system as well as a computer-implemented method for controlling storage, picking and distribution of a plurality of different goods, also making possible more precise logging of the inventory level of each item in the sales outlets.

### SUMMARY OF THE INVENTION

The object is achieved by the storage and distribution system according to the invention described in claim 1. This is designed for a plurality of different items, comprising the following elements: a central warehouse, designed for storing and picking the items in sales units and/or in packing units, in which several sales units of an item are packaged, and a plurality of sales outlets, designed to receive the supplied items from the central warehouse and to provide the items for sale in sales units and/or in packing units, wherein each sales outlet has devices for logging sales units and packing units of the delivered and sold items, and repacking between packing units and sales units. The system also has a database device connected to the central warehouse and the sales outlets, which device is designed (i) for storing and updating the number of sales units and packing units of each item stored in the central warehouse, and (ii) for storing and updating the number of sales units and packing units of each item respectively in stock in the sales outlets.

The present invention also proposes a computer-implemented method for controlling the storage, picking and distribution of a plurality of different items. This includes the method steps, carried out in a central warehouse, of accepting, storing and picking the items in sales units and/or in packing units in which several sales units of an item are packaged, as well as the method steps, carried out in a plurality of sales outlets, of: (a) receiving delivered items from the central warehouse, (b) logging the number of sales units and packing units of the delivered items, (c) providing the items for sale in sales units and/or packing units, (d) logging the number of sales units and packing units of sold items, and (e) logging repacking between packing units and sales units, as well as the method steps, carried out in a database device connected to the central warehouse and sales outlets, of (i) storing and updating the number of sales units and packing units of each item stored in the central warehouse, and (ii) storing and updating the number of sales units and packing units of each item respectively in stock in the sales outlets.

The invention makes possible better integrated warehouse management of sales units and packing units of the distributed items in sales outlets and thus savings in terms of time, space and cost. Moreover, the quantity of goods which exceed their best-before date prior to sale can be reduced.

In so doing, the data, associated with a sales outlet, of the stored sales units and packing units of the items in the range are preferably made available to an operator of the sales outlet for processing. The operator of the sales outlet, such as for example a supermarket, can optimise stock-keeping on the basis of these data.

In so doing, devices for logging repacking between packing units and sales units in a sales outlet can for example have a scanning apparatus for logging codes applied to the packing unit and/or sales unit.

In addition to one or more salerooms, sales outlets can for example additionally have one or storerooms or adjoining rooms, wherein a logging device is provided for separate logging and transmitting of the number of packing units and sales units of the items in stock in the salerooms and storerooms to the database device. These logging devices can have one or more light barriers and/or scanners for logging items passed between salerooms and storerooms.

One or more of the sales outlets can be designed as sorting section(s) and/or collection point(s) for goods deliveries to end customers for online trade.

According to the invention, a device can be provided for logging and storing best-before dates and/or use-by dates of delivered items in the database device, in order to minimise loss of fresh produce which has exceeded the best-before date.

Furthermore, a logging unit can be provided for logging a chronological development of the order sizes of the items in the range of individual sales outlets, and a checking unit set up to check a consistency of manual orders of the individual sales outlets using the logged chronological sequence of orders and the number in stock respectively of sales units and packing units of respective items. Thereby, the order sizes can be optimised using historical data, and errors in manual orders of goods minimised.

Furthermore, a forecasting unit can be provided for estimating future order sizes of individual sales outlets on the basis of logged past order sizes, wherein a machine-learning model can be used for estimating future order sizes.

### DESCRIPTION OF THE FIGURES

The invention is described in detail below with the help of embodiment examples, with reference to the drawings: There are shown in:

FIG. 1 a schematic representation of an embodiment example of a storage and distribution system according to the invention;

FIG. 2 a schematic representation of a central warehouse of the embodiment example of a storage and distribution system according to the invention;

FIG. 3 a cross-sectional view of the central warehouse according to FIG. 2;

FIG. 4 a schematic flow diagram to illustrate method steps of an embodiment example of the method according to the invention in respect of the central warehouse;

FIG. 5 a schematic flow diagram to illustrate method steps of an embodiment example of the method according to the invention in respect of a sales outlet;

FIG. 6 a schematic diagram to explain the functionality of an embodiment example of the storage and distribution system according to the invention; and

FIG. 7 a schematic diagram to explain a further aspect of the functionality of an embodiment example of the storage and distribution system according to the invention.

### DETAILED DESCRIPTION OF THE INVENTION

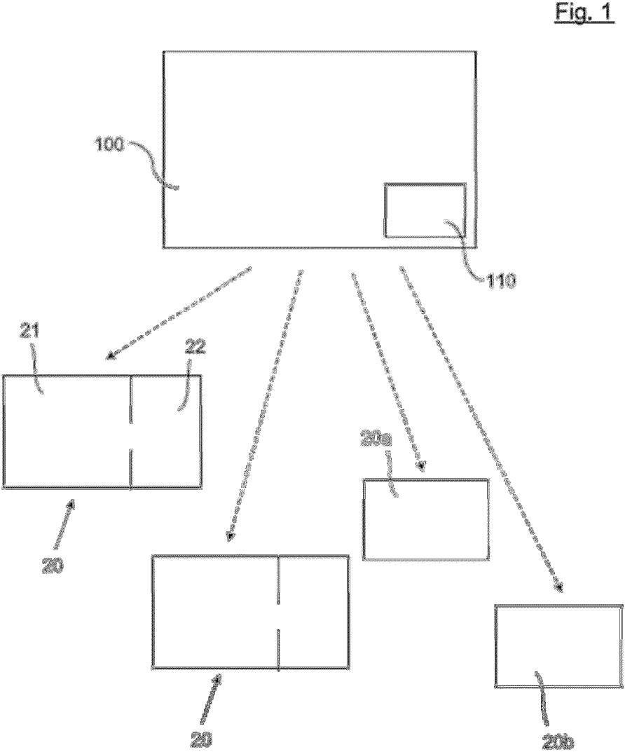

FIG. 1 shows a schematic representation of an embodiment example of a storage and distribution system according to the invention. This has a central warehouse 100 as well as several sales outlets 20, 20a, 20b. The sales outlets can be supermarkets, discount stores or superstores, which are numbered 20, or even collection points 20a or sorting sections 20b for online orders (e-commerce). The supermarkets 20 have one or more salerooms 21 in which the items for sale are offered, but can also have one or more storerooms or adjoining rooms 22 in which items are stored temporarily.

With the storage and distribution system according to the invention, all possible goods can be stored, picked and delivered to the sales outlets. In particular, the storage and distribution system according to the invention is suitable for food and other items for daily needs, which are typically sold in supermarkets of all sizes, discount stores and superstores. However, orders over the internet can also be integrated with the system according to the invention.

Typically, the items are offered for sale in in common household packages, for example a litre of milk, a bag of oat flakes, a bottle of water, a sack of dog food etc. These common household packing units (often also called “pieces”) will be called sales units here. However, this name is not to be understood as being limited to a specific type or size of packaging.

For the purpose of the items being delivered by the producer to the central warehouse 100 and for storage in the central warehouse 100, frequently several sales units are combined to form a packing unit (also called a “case”), e.g. ten bags of milk making a ten-pack or six 1.5-litre PET water bottles making a bundle. Such combined sales units will be called packing units here. This name is also not to be understood as limiting. The storage and distribution system according to the invention is suitable for processing all possible types of packaging.

The central warehouse 100 has a control module 110 which comprises a database system for logging and updating the number of items in stock in central warehouse 100 and sales outlets 20, 20a, 20b, wherein the packing units and sales units of the items are logged separately. In the schematic representation of FIG. 1, the control module and thus the database system are assigned to the central warehouse 100. The control module 110 can also be arranged spatially separated from central warehouse 100. Moreover, according to the invention, several central warehouses 100 can be controlled by means of a control module 110.

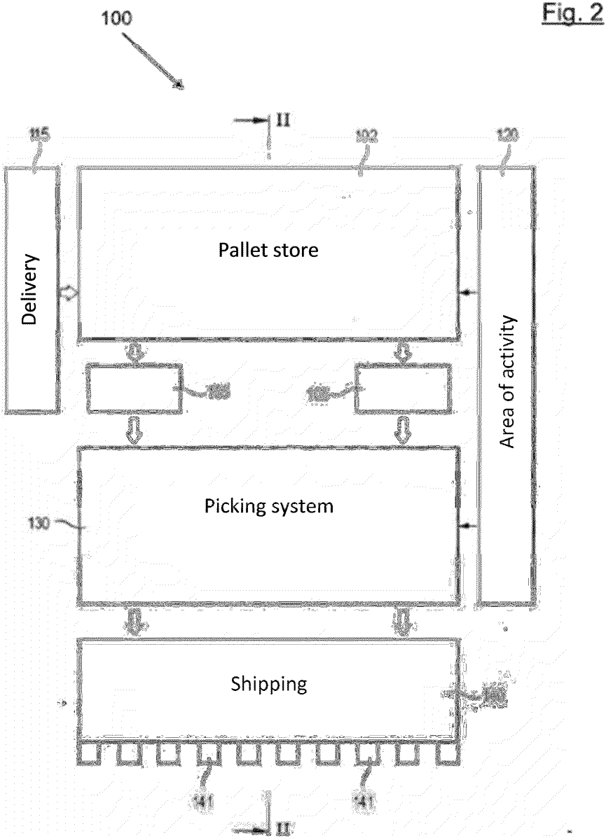

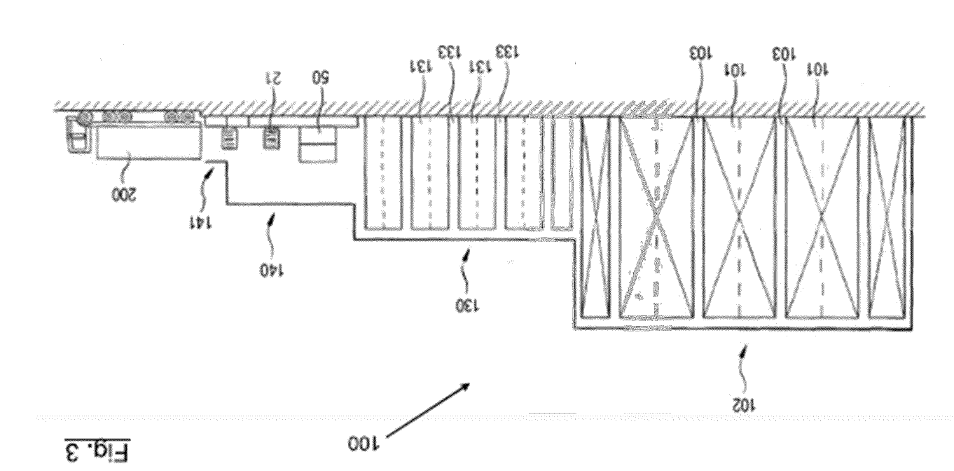

An embodiment example of a central warehouse is described below with reference to FIGS. 2 and 3. The storage and distribution system according to the invention as well as the method according to the invention are, however, not limited to a specific type of central warehouse.

FIG. 2 shows, schematically in a top view, an embodiment example of a central warehouse 100, and FIG. 3 a cross-sectional view along line II-II of FIG. 2.

A receiving store 102 is for example designed as a pallet store, i.e. the items or goods delivered to a delivery station 115 are stored on the delivery pallets in a pallet store 102 in rows of shelves 101. Retrieval vehicles known per se can be driven in the racking aisles 103 designed between the rows of shelves 101 (see FIG. 3), which vehicles transfer the delivered storage pallets into the shelf storage. For example, a likewise automated picking system 130 is connected to the shelf storage via a preferably automated conveyance.

As schematically represented in FIG. 2, an area of activity 120 is connected laterally to the pallet store 102 and the automatic storing and picking system 130, which area serves for maintenance and repairs, and can also contain for example a warehouse management computer. In turn, a shipping zone 140 is connected to the automatic storing and picking system 130, where loading equipment, such as for example order pallets, are loaded with the items required for a picking order of one or more sales outlets 20. The stacks formed on the pallet are loaded into a lorry 200 via a lorry ramp 141 on the same level. Preferably, the stacks consists of different items as packing units. However, mixed stacks, consisting of packing units and sales units of different items, are also possible. The lorry transports the ordered items on a route which has been optimised for example in terms of journey time to the individual sales outlets 20.

The database system can be a system consisting of known hardware and software components which can also be connected to an enterprise resource planning (ERP) system. The database system of the storage and distribution system according to the invention is set up to log the items delivered to and supplied from central warehouse 100, as well as items delivered to the respective sales outlets 20, 20a, 20b, and items sold respectively in the sales outlets. Items sold can for example be logged using existing cash register systems. Likewise, incoming goods are inspected in sales outlets, while goods returned from salerooms 21 into storerooms or adjoining rooms 22 are also inspected. The inventory level of the items in central warehouse, in sales outlets including sorting sections and collection points for e-commerce, as well as in lorries can thus be logged and updated preferably in real time. According to the invention, in so doing, the number of packing units and sales units of the individual items are respectively logged separately. However, in so doing it is necessary that “unpacking” and “distributing” a packing unit into several sales units is logged, e.g. in a sales outlet, for example by means of a hand scanner or comparable device. Logging packing units and sales units separately helps in particular operators of sales outlets to carry out more precise stock-keeping and provides a better overview of the quantity of items respectively in stock. Logging packing units and sales units separately is also very useful for stock-keeping in online trade, as here the majority of order sizes, which are mostly supplied in the form of packing units, are small and from end customers.

According to a preferred variant of the invention, it is also possible to log separately the items in stock in the saleroom 21 of a sales outlet 20 and the sales units and packing units stored in a separate storeroom 22 of same. It can thereby be prevented that items in stock in a (potentially confusing) storeroom or adjacent room of a sales outlet are overlooked or forgotten. However, it is then necessary to log in the warehouse management system items being passed between salerooms and storeroom, for example by means of a light barrier or using hand-scanners.

Preferably, the items stored in the database are assigned a best-before date or use-by date, whereby in particular the deterioration of fresh produce can be minimized.

The invention also proposes a computer-implemented method for controlling storage, picking and distribution of a plurality of different items which, as described, are stored and distributed as sales units and packing units.

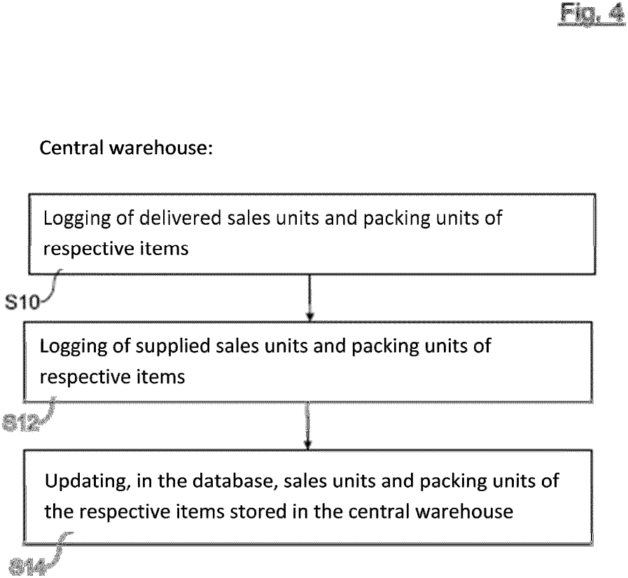

The method steps carried out in a central warehouse 100 are illustrated schematically in FIG. 4, comprising method step S10 of logging the sales units and packing units of the respective items delivered into the central warehouse. In method step S12, the sales units and packing units of the respective items supplied by the central warehouse are logged. Thereafter, in method step S14, the number of packing units and sales units of the stored items respectively in stock in the central warehouse 100 can be updated in the database.

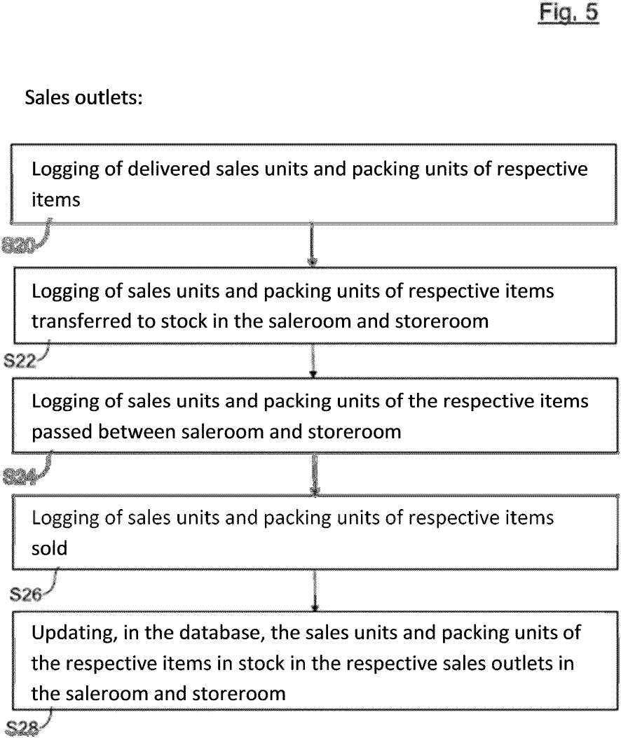

The method steps carried out in the sales outlets 20, 20a, 20b are illustrated schematically in FIG. 5: In method step S20, the sales units and packing units of the respective items delivered into the respective sales outlet 20 are logged. In method step S22, the sales units and packing units of the respective items transferred into stock in the respective sales outlets 20 in saleroom 21 and in storeroom 22 are logged. Moreover, in a method step S24, the sales units and packing units of the respective items passed between saleroom 21 and storeroom 22 are logged on an ongoing basis. In a further method step (not represented in FIG. 5), sales units “unpacked” from a packing unit are logged, for example by scanner or camera. Self-evidently, the items sold typically in saleroom 22 are also logged, preferably by means of a cash register system. Finally, in method step S28, each change in status is registered in the database. Therefore, in FIG. 5, the method steps are not necessarily chronologically represented. As soon as a change in sales units or packing units in stock in the saleroom and/or storeroom is registered, this change is updated in the database. It should also be noted that method step S28 takes place typically not in the individual sales outlets 20 but in the control unit 110, where the database entries are updated in respect of the respective sales outlets.

The data of the stored sales units and packing units of the items associated with a sales outlet are made available to an operator of the sales outlet for further processing. For each sales outlet, the chronological development of order sizes of items in the range can be logged. This enables orders to be optimised and checked, and future order sizes of different items to be forecast. Machine-learning models can be used for forecasting. Depending on the stock size in the individual sales outlets, goods appropriate to the capacity of the respective storeroom 22 can be delivered from the central warehouse 100 in an anticipatory manner, and above all in peak times central warehouses and transport logistics can be optimised, and flows of goods streamlined.

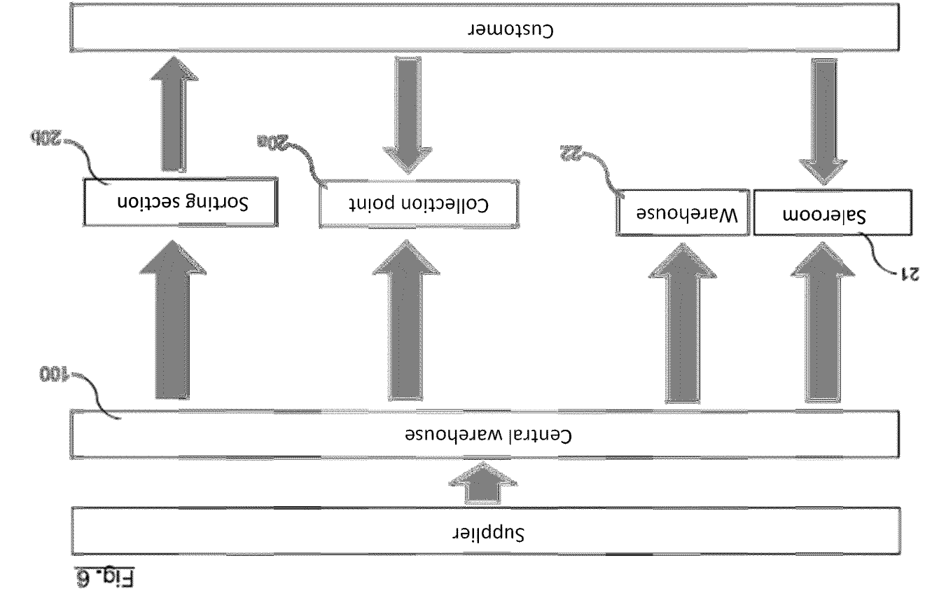

FIG. 6 shows a schematic diagram to explain the functionality of the application of an embodiment example of the storage and distribution system according to the invention to a multichannel distribution system.

The goods are delivered from the suppliers to the central warehouse, and stored there. With an order, the corresponding quantities of packing units and sales units of ordered items are delivered to the sales outlets, i.e. typical markets as well as collection points 20a and sorting sections 20b for e-commerce. The customers purchase the goods in a saleroom 21 of a market, or collect these from a collection point 20a. Alternatively, the goods can be delivered from a sorting section 20b to the home of a customer. The flows of goods of all three distribution channels are modelled integrated by the system according to the invention.

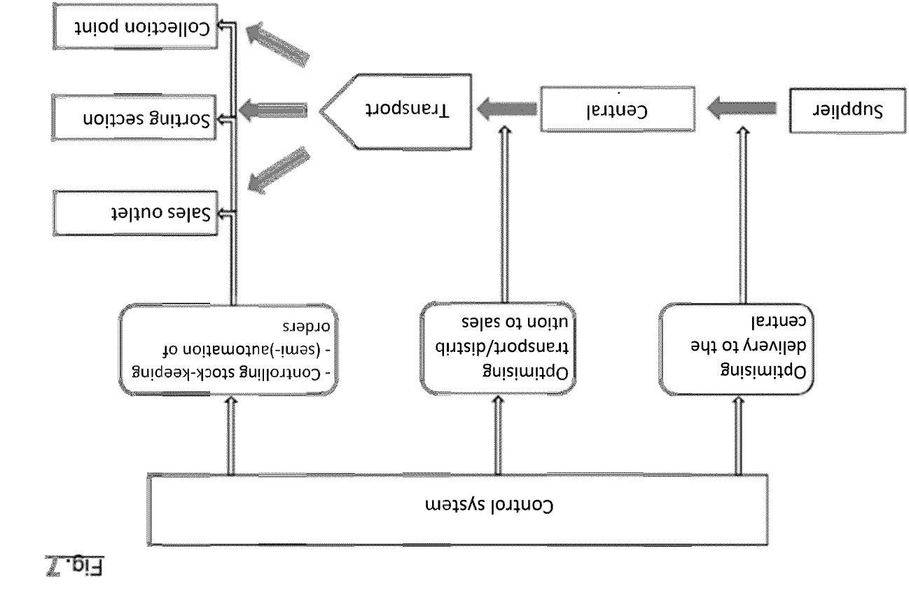

FIG. 7 shows schematically the optimisation and control possibilities in the integrated supply chain from supplier to end customer.

Delivery to the central warehouse 100 can be optimized in respect of the capacity of individual products to be transferred to stock. Transport between central warehouse 100 and the sales outlets 20, 20a, 20b can be controlled and optimised in respect of journey time of lorries or even footfall in the sales outlets. Furthermore, as explained above, stock-keeping in the different types of sales outlets, on the basis of (real-time) data of the sales units and packing units of the respective items respectively in stock, can be improved and adapted on an ongoing basis, whereby costs can be reduced, and customer-friendly service can be improved. Even returns, which are frequent in online transactions, can be taken into account by the storage and distribution system according to the invention.

1-17. (canceled)

18. A storage and distribution system for a plurality of different items, wherein the system comprises:
(a) a central warehouse, configured for storing and picking the items in sales units and/or in packing units, in which several sales units of an item are packaged,
(b) a plurality of sales outlets, configured to receive the supplied items from the central warehouse and to provide the items for sale in sales units and/or in packing units, each sales outlet comprising devices for logging
sales units and packing units of the delivered and sold items, and
repacking between packing units and sales units,
(c) a database device connected to the central warehouse and the sales outlets, which device is configured for
storing and updating a number of sales units and packing units of each item stored in the central warehouse, and
storing and updating the number of sales units and packing units of each item respectively in stock in the sales outlets.

19. The storage and distribution system of claim 18, wherein the central warehouse comprises devices for logging the packing units and sales units of delivered and supplied items.

20. The storage and distribution system of claim 18, wherein the database system is configured to make available data, associated with a sales outlet, of the stored sales units and packing units of the items in a range to an operator of the sales outlet for processing.

21. The storage and distribution system of claim 18, wherein devices for logging repacking between packing units and sales units in a sales outlet comprise a scanning apparatus for logging codes applied to a packing unit and/or sales unit.

22. The storage and distribution system of claim 18, wherein the system comprises sales outlets with separate salerooms and storerooms, each of which comprises a logging device for separate logging and transmitting to the database device a number of packing units and sales units respectively in stock in the salerooms and storerooms.

23. The storage and distribution system of claim 22, wherein a logging device provided in the sales outlets comprises a light barrier and/or a scanner for logging items passed between salerooms and storerooms.

24. The storage and distribution system of claim 18, wherein the system comprises sales outlets configured as sorting sections and/or collection points for goods deliveries to end customers.

25. The storage and distribution system of claim 18, wherein the system further comprises a device for logging and storing best-before dates and/or use-by dates of delivered items in the database device.

26. The storage and distribution system of claim 18, wherein the system further comprises a logging unit for logging a chronological development of order sizes of the items in a range of individual sales outlets, and a checking unit set up to check a consistency of manual orders of the individual sales outlets using the logged chronological sequence of orders and the number in stock respectively of sales units and packing units of respective items.

27. The storage and distribution system of claim 26, wherein the system further comprises a forecasting unit for estimating future order sizes of individual sales outlets on the basis of logged past order sizes, a machine-learning model being used for estimating future order sizes.

28. A computer-implemented method for controlling the storage, picking and distribution of a plurality of different items, wherein the method comprises:
in a central warehouse:
accepting, storing and picking the items in sales units and/or in packing units in which several sales units of an item are packaged,
in a plurality of sales outlets:
(a) receiving delivered items from the central warehouse,
(b) logging a number of sales units and packing units of the delivered items,
(c) providing the items for sale as sales units and/or packing units,
(d) logging a number of sales units and packing units of sold items, and
(e) logging repacking between packing units and sales units,
in a database device connected to the central warehouse and sales outlets:
(i) storing and updating a number of sales units and packing units of each item stored in the central warehouse, and
(ii) storing and updating a number of sales units and packing units of each item respectively in stock in the sales outlets.

29. The method of claim 28, wherein data, associated with a sales outlet, of the stored sales units and packing units of the items in a range are made available to an operator of the sales outlet for processing.

30. The method of claim 28, wherein the method further comprises logging and transmitting to the database device packing units and sales units of items in a range in separate salerooms and storerooms of the sales outlets.

31. The method of claim 30, wherein a number of articles passed between salerooms and storerooms is logged.

32. The method of claim 28, wherein best-before dates and/or use-by dates of delivered items are logged and stored in the database device.

33. The method of claim 28, wherein the method further comprises logging a chronological development of order sizes of items in a range in individual sales outlets, and checking consistency of manual orders of individual sales outlets using a logged chronological sequence of orders and a number of sales units and packing units of each item respectively in stock.

34. The method of claim 33, wherein the method further comprises estimating future order sizes of individual sales outlets on the basis of logged past order sizes, a machine-learning model being used for estimating future order sizes.
